(19) United States
(12) Patent Application Publication
(10) Pub. No.: US 2010/0095724 A1
(43) Pub. Date: Apr. 22, 2010

(54) METAL FORMING WITH VIBRATION ASSIST

(76) Inventors: Seetarama S. Kotagiri, Rochester Hills, MI (US); Dalip K. Matharoo, Orion, MI (US); Rennie J. Santilli, Oakland, MI (US)

Correspondence Address: MAGNA INTERNATIONAL, INC., 337 MAGNA DRIVE, AURORA, ON, L4G-7K1, CA

(21) Appl. No.: 12/445,327

(22) PCT Filed: Oct. 12, 2007
(86) PCT No.: PCT/CA2007/001800

§ 371 Date: Apr. 13, 2009

Related U.S. Application Data
(60) Provisional application No. 60/851,812, filed on Oct. 13, 2006.

(51) Int. Cl. B21D 37/00; B21D 26/02; B23P 25/00; B23Q 11/00

(52) U.S. Cl. 72/61; 72/354.6

(57) ABSTRACT

A metal forming die includes a first die half and a second die half moveable relative to the first die half. The first and second die halves define a die cavity when the second die half is in a closed position. A transducer is operable to vibrate the first die half during metal forming.

### FIELD OF INVENTION

The present invention relates to metal forming techniques. More particularly, the present invention relates to an apparatus and method for vibration assisted metal stamping and hydroforming.

### BACKGROUND OF INVENTION

Hydroforming is well known in the art. Examples of hydroforming techniques and parts and assemblies manufactured utilizing hydroforming are provided in the following U.S. Pat. Nos.: 5,205,187; 5,259,268; 5,403,049; 5,561,902; 5,632,508; 5,718,048; 5,794,398; 5,802,899; 5,850,695; 5,855,394; 5,862,877; 5,899,498; 5,953,945; 5,960,660; 5,979,201; 5,987,950; 6,014,879; 6,065,502; 6,092,865; 6,158,122; 6,158,772; 6,282,790; 6,302,478; 6,412,857; 6,474,534; 6,533,348; 6,543,266; 6,566,624; 6,609,301; 6,621,037; 6,623,067; 6,662,611; 6,689,982; 6,713,707; 6,739,624.

Hydroforming typically includes inserting a metal tube between first and second die halves and subsequently closing the die. The first and second die halves include die cavities shaped to define a desired external surface of the metal member after the hydroforming process has been completed. As such, voids exist between an outer surface of the metal tube and the die halves prior to hydroforming. A pressurized fluid, typically water, is applied to an inner surface of the metal tube to cause the metal to deform and substantially conform to the shape of the die cavities.

Challenges in hydroforming exist relating to the maximum amount of dimensional change from an initial tube geometry that may be obtained. Limiting factors include friction between the die and the outer surface of the metal tube, lubricant application, and metal tube rupture. Furthermore, relatively high hydraulic pressures have been required to form certain metal structures. Challenges also exist when attempting to completely fill a die cavity with material having relatively small corner radii.

Sheet metal stamping dies and presses have also been used to construct a number of structural components. Due to the mechanical properties of the material being formed in combination with the characteristics of a stamping die, existing manufacturing methods may be limited regarding a maximum depth of draw and minimum corner radii that may be repeatedly formed in a high volume production process. In addition, relatively expensive lubricants are used to reduce friction between the die surfaces and the component being formed. Application and handling of these lubricants may be unwieldy, time consuming and expensive.

While a number of metallic structures are presently constructed using hydroforming or stamping techniques, a need exists for an improved process to reduce friction between the die and the material to be formed. It may also be advantageous to implement vibration forming during metal stamping or hydroforming operations to reduce or eliminate the need for lubrication.

### SUMMARY OF INVENTION

The present disclosure relates to a metal forming die including a first die half and a second die half moveable relative to the first die half. The first and second die halves define a die cavity when the second die half is in a closed position. A transducer is operable to vibrate the first die half during metal forming.

Further areas of applicability will become apparent from the description provided herein. It should be understood that the description and specific examples are intended for purposes of illustration only and are not intended to limit the scope of the present disclosure.

### DESCRIPTION OF THE DRAWINGS

The drawings described herein are for illustration purposes only and are not intended to limit the scope of the present disclosure in any way.

FIG. 1 is a schematic representation of a cross-sectional side view of a hydroforming die; and

FIG. 2 is a schematic representation of a cross-section of a metal stamping die.

### DETAILED DESCRIPTION OF THE INVENTION

The following description is merely exemplary in nature and is not intended to limit the present disclosure, application, or uses.

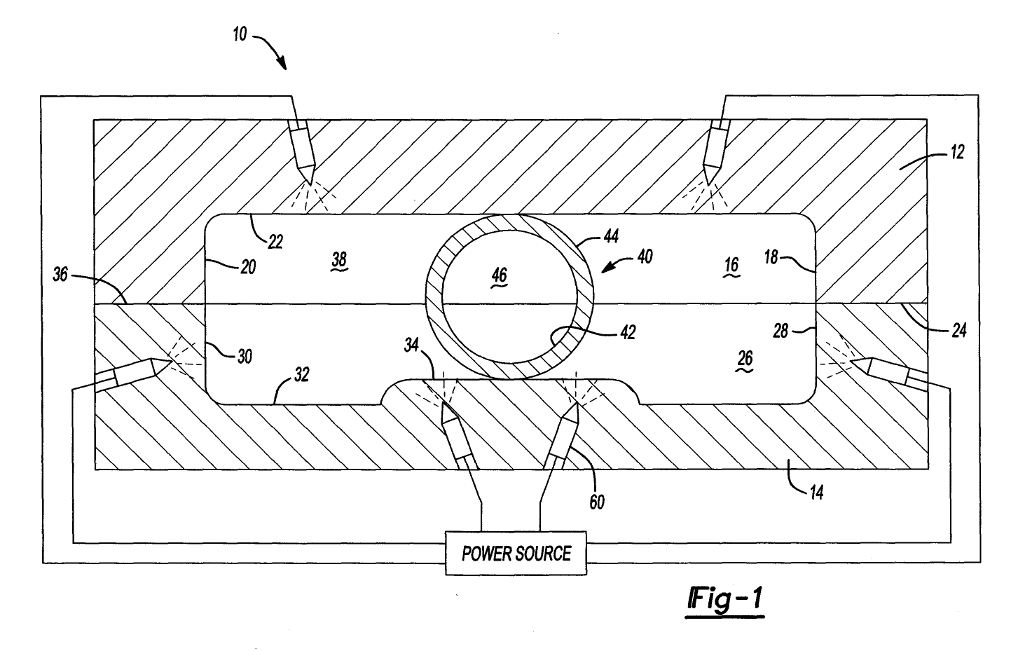

FIG. 1 depicts an exemplary hydroforming die 10 having a first die half 12 and a second die half 14 in communication with one another. First die half 12 includes a cavity 16 including a first side wall 18 and a second side wall 20 interconnected by a top wall 22, defining radii or corners therebetween. First die half 12 includes a mating surface 24.

Second die half 14 includes a cavity 26 defined by a first side wall 28, a second side wall 30 and a bottom wall 32 interconnecting the first and second side walls, defining radii or corners therebetween. A negative emboss or recess 34 inwardly extends from bottom wall 32, having radii or corners therebetween. Second die half 14 includes a mating surface 36 in engagement with mating surface 24 when hydroforming die 10 is closed.

To create a hydroformed component, a workpiece 40 is inserted between first die half 12 and second die half 14 when the die halves are spaced apart from one another and the hydroforming die is in an open condition. Workpiece 40 is an elongated hollow member having an inner surface 42 and an outer surface 44. Inner surface 42 bounds an inner volume 46. It should be appreciated that the geometry of workpiece 40 may vary depending on the final component geometry to be obtained.

In particular, it is contemplated that workpiece 40 may have a substantially cylindrical cross section as shown in FIG. 1. Alternatively, workpiece 40 may have an oblong or flattened cross section or any number of predefined shapes. Additional special geometrical shapes, such as flats or indentations, may extend for only a predetermined distance or along the entire length of workpiece 40.

Workpiece 40 may have two open ends or may include one open end and a blind or closed end. In similar fashion, hydroforming die may have two open ends or one closed end and one open end depending on the part to be formed. To continue the hydrofoming process, fittings (not shown) are coupled to the ends of workpiece 40 to place inner volume 46 in communication with pressurized fluid. A transducer 60 is coupled to first die half 12 and additional transducers 60 may also be coupled to second die half 14 or vice versa. Transducers 60 are preferably located near the radii or corners, where friction is relatively high during the metal forming process. Transducers 60 are electrically connected to a power source and operable to impart a vibration into the die to cause relative movement between workpiece 40 and at least one of first die half 12 and second die half 14.

Although the present disclosure illustrates the die cavity 26 as having right angled corners, it is readily understood by those skilled in the art that the die cavity 26 may have any desired shaping. The transducer 60 is positioned near the radii or corners, where friction is relatively high during the metal forming process. Computer simulation programs are available that will simulate the metal forming process. These programs may be utilized to determine areas where friction may cause problems during the metal forming process. The transducers 60 are positioned near problem regions to reduce or minimize friction between the die surface and the workpiece.

To complete the hydroforming process, transducers 60 are powered to vibrate hydraulic die 10 while the die is closing and/or when pressurized fluid contained in inner volume 46 is pressurized to deform workpiece 40 and cause outer surface 44 to conform to the shape of cavity 38. As is known in the art, particularly U.S. Pat. Nos. 5,987,950 and 5,979,201 the closing of the first half die 12 by moving it relative to the second half die 14, can also result in metal deformation of the workpiece 40. The vibration causes portions of workpiece 40 to more freely move relative to the surfaces of first die cavity 16 and second die cavity 26. Improved material flow results in workpiece 40 more completely conforming to the shape of cavity 38 especially at locations having relatively small radii. It is contemplated that the use of transducers 60 may reduce or entirely eliminate the need for lubricants between outer surface 44 and the surfaces of first die half 12 and second die half 14.

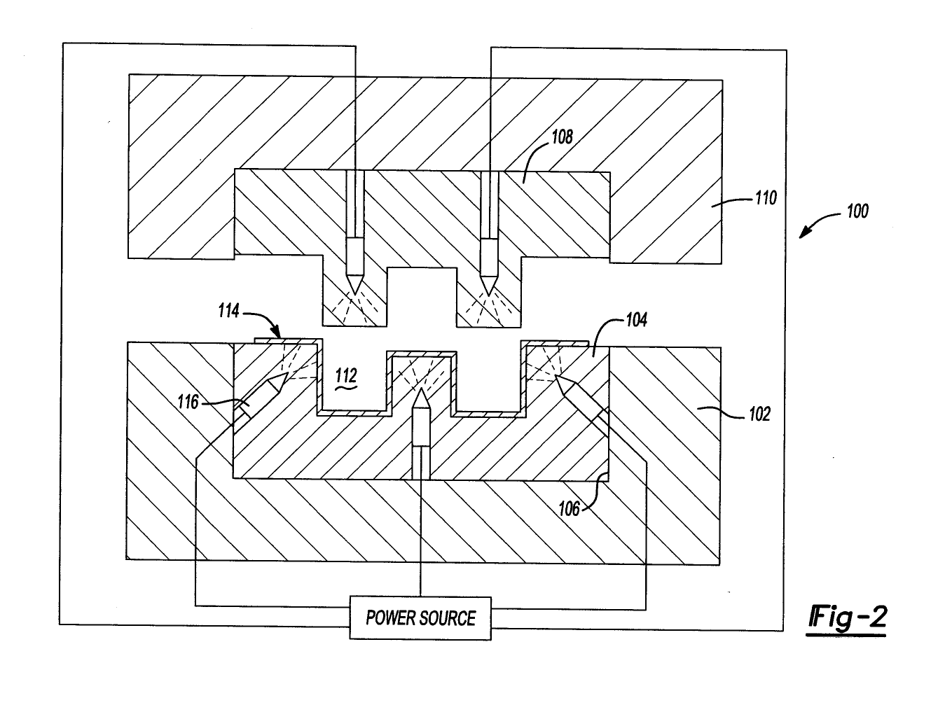

FIG. 2 depicts another vibration assisted metal forming tool at reference numeral 100. Tool 100 includes a base 102 and a lower die insert 104 positioned within a pocket 106 formed within base 102. An upper die insert 108 is coupled to a ram 110. Ram 110 is operable to move upper die insert 108 relative to lower die insert 104 between open and closed positions. Lower die insert 104 defines a cavity 112 shaped to correspond or complementary to an outer surface of a workpiece 114 after the stamping operation has been completed. Upper die insert 108 includes a complementary shape to cavity 112. The exact relative dimensions between cavity 112 and the profile of upper die insert 108 are determined by taking into account the thickness of workpiece 114 and other metal forming characteristics.

Transducers 116 are coupled to lower die insert 104. Transducers 116 are operable to vibrate lower die insert 104 while the stamping operation is being performed. During the stamping process, workpiece 114 is encouraged to move relative to lower insert 104 based on the vibratory input from transducers 116. By introducing vibration into the forming process, improved material flow results due to reduced friction between die inserts 104, 108 and workpiece 114. Material flow into the corner radii of the die is increased. Furthermore, an increased depth of draw may be possible through the use of the vibration assisted metal forming as defined in this disclosure.

Once ram 110 drives upper die insert 108 to its fully extended or closed position, transducers 116 are controlled to no longer vibrate lower die insert 104. Upper die insert 108 is moved to the open position by retracting ram 110. The completely formed part may now be removed from tool 100.

Furthermore, the foregoing discussion discloses and describes merely exemplary embodiments of the present invention. One skilled in the art will readily recognize from such discussion, and from the accompanying drawings and claims, that various changes, modifications and variations may be made therein without departing from the scope of the invention as defined in the following claims.

What is claimed is:

1. A metal forming die assembly comprising:
a first die half;
a second die half being moveable relative to the first die half between open and closed positions, said first and second die halves cooperate to define a die cavity when said second die half is in said closed position; and
a transducer mounted in one of said first and second die halves and operable to vibrate said one of first and second die halves during metal forming.

2. The die assembly of claim 1 wherein the transducer is operable to cause said one of first and second die half to vibrate at a relatively high frequency and a relatively low amplitude.

3. The die assembly of claim 2 wherein said die cavity has a corner and said transducer is located near said corner.

4. The die assembly of claim 3 wherein said assembly further comprises additional transducers mounted in said first and second die halves.

5. The die assembly of claim 4 wherein each of said transducers are mounted near corner radii of said first and second die halves.

6. The die assembly of claim 5 wherein the first and second die halves form a hydroforming die.

7. The die assembly of claim 5 wherein the first and second die halves form a stamping die.

8. A metal forming process comprising:
providing a first die half having a transducer and juxtaposing the first die half relative to a second die half to define in an open position, the first die half cooperating with the second die half to define a cavity;
positioning at least a portion of a metal workpiece between the first and second die halves;
exciting a transducer to vibrate the first die half; and
moving the first half die relative to the second half die from the open position to a closed position and forming the workpiece to substantially conform to a shape of the cavity.

9. The metal forming process of claim 8 wherein the forming of the workpiece occurs as the first die half is closed relative to the second die half.

10. The metal forming process of claim 8 wherein an initial amount of forming of the workpiece occurs as the first die half is closed relative to the second die half and a remaining amount of formation results from hydroforming the workpiece.

11. The metal forming process of claim 8 wherein the forming step is hydroforming.

12. The metal forming process of claim 8 further including a step of exciting another transducer to vibrate the second die half during the forming step.

13. The metal forming process of claim 12 wherein the forming of the workpiece occurs as the first die half is closed relative to the second die half.

14. The metal forming process of claim 12 wherein an initial amount of forming of the workpiece occurs as the first die half is closed relative to the second die half and a remaining amount of formation results from hydroforming the workpiece.

15. The metal forming process of claim 12 wherein the forming step is hydroforming.
